(19) United States
(12) Patent Application Publication
(10) Pub. No.: US 2026/0001969 A1
(43) Pub. Date: Jan. 1, 2026

(54) DYNAMICALLY VULCANIZED COMPOSITIONS COMPRISING ALIPHATIC POLYKETONE, FUNCTIONALIZED RUBBER, AND LOW-ODOR CROSSLINKING COMPOUND

(71) Applicant: AVIENT CORPORATION, Avon Lake, OH (US)

(72) Inventors: Nathan DREGER, Copley, OH (US); Zachary ZANDER, Lake Geneva, WI (US)

(21) Appl. No.: 18/993,155

(22) PCT Filed: Jul. 13, 2023
(86) PCT No.: PCT/US2023/070182

§ 371 Date: Jan. 10, 2025

Related U.S. Application Data
(60) Provisional application No. 63/389,685, filed on Jul. 15, 2022.

(51) Int. Cl. C08C 19/02; C08J 3/24; C08K 5/07

(52) U.S. Cl. CPC C08C 19/02; C08J 3/24; C08K 5/07

(57) ABSTRACT

Embodiments of the present disclosure are directed to dynamically vulcanized compositions including the reaction product of, based on a total weight of the dynamically vulcanized composition, about 5 wt % to about 70 wt % of an aliphatic polyketone, about 30 wt % to about 95 wt % of a functionalized rubber, and about 0.1 wt % to about 5 wt % of a low-odor crosslinking compound.

### CLAIM OF PRIORITY

This application claims the benefit of U.S. Provisional Patent Application Ser. No. 63/389,685 bearing Attorney Docket Number 1202208 and filed on Jul. 15, 2022, which is hereby incorporated by reference in its entirety.

### TECHNICAL FIELD

Embodiments of the present disclosure are generally related to vulcanized compositions, and are specifically related dynamically vulcanized compositions including an aliphatic polyketone, a functionalized rubber, and a low-odor crosslinking compound having improved heat resistance and reduced Shore A hardness and tensile modulus.

### BACKGROUND

Thermoplastic vulcanizates may have desirable mechanical properties. However, such conventional thermoplastic vulcanizates may not have properties suitable for use in the preparation of flexible parts for high temperature applications.

Accordingly, a continual need exists for improved vulcanized compositions having increased heat resistance while providing reduced hardness and tensile modulus.

### SUMMARY

Embodiments of the present disclosure are directed to dynamically vulcanized compositions comprising an aliphatic polyketone, a functionalized rubber, and a low-odor crosslinking compound, which have improved heat resistance (i.e., reduced compression set) and improved flexibility (i.e., reduced Shore A hardness and tensile modulus).

According to one embodiment, a dynamically thermoplastic vulcanized composition is provided. The dynamically thermoplastic vulcanized composition comprises the reaction product of, based on a total weight of the dynamically vulcanized composition, about 5 wt % to about 70 wt % of an aliphatic polyketone, about 30 wt % to about 95 wt % of a functionalized rubber, and about 0.1 wt % to about 5 wt % of a low-odor crosslinking compound.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DRAWINGS

FIG. 1 is an atomic force microscope image of a comparative composition;

FIG. 2 is an atomic force microscope image of a comparative composition;

FIG. 3 is an atomic force microscope image of a comparative composition; and

FIG. 4 is an atomic force microscope image of an exemplary dynamically vulcanized composition, according to one or more embodiments described herein.

### DETAILED DESCRIPTION

Reference will now be made in detail to various embodiments of dynamically vulcanized compositions, specifically, dynamically vulcanized compositions comprising the reaction product of, based on a total weight of the dynamically vulcanized composition, about 5 wt % to about 70 wt % of an aliphatic polyketone, about 30 wt % to about 95 wt % of a functionalized rubber, and about 0.1 wt % to about 5 wt % of a low-odor crosslinking compound.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The term “wt %,” as described herein, refers to the weight fraction of the individual reactants of the formulation used to produce the reaction product that comprises the dynamically vulcanized composition, unless otherwise noted. For simplicity purposes, “wt %” will be referred to throughout as the amount based on a total weight of the dynamically vulcanized composition.

The term “Shore A hardness,” as described herein, refers to the hardness of a material as measured according to ASTM D2240.

The term “tensile modulus,” as described herein, refers to the ratio of the stress along an axis over the strain along that axis as measured according to ASTM D638 at 23° C. and a rate of strain of 8.5 mm/s.

The term “compression set,” as described herein, refers to the ability of a material to return to its original thickness after prolonged compressive stress as measured according to ASTM D395 at the temperature indicated.

The term “melt flow rate,” as described herein, refers to the ability of a material's melt to flow under pressure as measured according to ASTM D1238 at the given temperature and given weight.

The term “specific gravity,” as described herein, refers to the ratio of the density of a material to the density of water as measured according to ASTM D792 at 23° C.

As discussed hereinabove, thermoplastic vulcanizates, such as those including polyolefin and polyamide, may have desirable mechanical properties. However, such conventional thermoplastic vulcanizates may not have properties suitable for use in the preparation of flexible parts for high temperature applications.

Disclosed herein are dynamically vulcanized compositions, which mitigate the aforementioned problems. Specifically, the dynamically vulcanized compositions disclosed herein comprise the reaction product of, based on a total weight of the dynamically vulcanized composition, about 5 wt % to about 70 wt % of an aliphatic polyketone, about 30 wt % to about 95wt % of a functionalized rubber, and about 0.1 wt % to about 5 wt % of a low-odor crosslinking compound, which results in a dynamically vulcanized composition having improved heat resistance (i.e., reduced compression set) and improved flexibility (i.e., reduced Shore A hardness and tensile modulus). The inclusion of the low-odor crosslinking compound to crosslink improves the miscibility between the aliphatic polyketone and the functionalized rubber, thereby improving the heat resistance and flexibility of the resulting dynamically vulcanized composition.

The dynamically vulcanized composition disclosed herein may generally be described as the reaction product of an aliphatic polyketone, a functionalized rubber, and a low-odor crosslinking compound.

### Aliphatic Polyketone

The dynamically vulcanized composition described herein comprises an aliphatic polyketone. Those skilled in the art will appreciate that aliphatic polyketones include polymers prepared from carbon monoxide and at least one olefin. In embodiments, the molar ratio of carbon monoxide to olefin in the aliphatic polyketone may be in the range of 1.2:1 to 1:1.2, 1.1:1 to 1:1.1, or 1.05:1 to 1:1.05. Suitable olefins for use in an aliphatic polyketone include ethylene and propylene. In embodiments, the aliphatic polyketone is a copolymer of carbon monoxide and ethylene. In embodiments, the aliphatic polyketone is a copolymer of carbon monoxide, ethylene, and a second olefin having at least 3 carbon atoms. In embodiments, the aliphatic polyketone is a copolymer of carbon monoxide, ethylene, and propylene. In some embodiments where the olefin content of the aliphatic polyketone is ethylene and propylene, the weight percent of the total olefin content may be up to 20 wt %, 15 wt %, 10 wt %, or 5 wt % propylene with the balance of the olefin content being ethylene.

Inclusion of aliphatic polyketones may result in improved properties as compared to conventional polyolefin and polyamide thermoplastic vulcanizates. In particular, the aliphatic polyketone has ketone functionalities on every repeat unit of the base polymer which allows for crosslinking at multiple locations along the polymer, leading to improved heat resistance. In contrast, polyamide only couples at the ends of the polymer. In embodiments, the dynamically vulcanized composition may be free of a polyamide polymer.

In embodiments, the aliphatic polyketone may have a melt flow rate (240° C./2.16 kg) greater than or equal to about 3 g/10 min. In embodiments, the aliphatic polyketone may have a melt flow rate (240° C./2.16 kg) less than or equal to about 200 g/10 min. In embodiments, the aliphatic polyketone may have a melt flow rate (240° C./2.16 kg) greater than or equal to about 3 g/10 min, greater than or equal to about 5 g/10 min, greater than or equal to about 10 g/10 min, greater than or equal to about 25 g/10 min, or even greater than or equal to about 50 g/10 min. In embodiments, the aliphatic polyketone may have a melt flow rate (240° C./2.16 kg) less than or equal to about 200 g/10 min, less than or equal to about 150 g/10 min, less than or equal to about 100 g/10 min, less than or equal to about 50 g/10 min, less than or equal to about 25 g/10 min, or even less than or equal to about 10 g/10 min. In embodiments, the aliphatic polyketone may have a melt flow rate (240° C./2.16 kg) from about 3 g/10 min to about 200 g/10 min, from about 3 g/10 min to about 150 g/10 min, from about 3 g/10 min to about 100 g/10 min, from about 3 g/10 min to about 50 g/10 min, from about 3 g/10 min to about 25 g/10 min, from about 3 g/10 min to about 10 g/10 min, from about 5 g/10 min to about 200 g/10 min, from about 5 g/10 min to about 150 g/10 min, from about 5 g/10 min to about 100 g/10 min, from about 5 g/10 min to about 50 g/10 min, from about 5 g/10 min to about 25 g/10 min, from about 5 g/10 min to about 10 g/10 min, from about 10 g/10 min to about 200 g/10 min, from about 10 g/10 min to about 150 g/10 min, from about 10 g/10 min to about 100 g/10 min, from about 10 g/10 min to about 50 g/10 min, from about 10 g/10 min to about 25 g/10 min, from about 25 g/10 min to about 200 g/10 min, from about 25 g/10 min to about 150 g/10 min, from about 25 g/10 min to about 100 g/10 min, from about 25 g/10 min to about 50 g/10 min, from about 50 g/10 min to about 200 g/10 min, from about 50 g/10 min to about 150 g/10 min, or even from about 50 g/10 min to about 100 g/10 min, or any and all subranges formed from any of these endpoints.

In embodiments, the aliphatic polyketone may have a tensile modulus greater than or equal to about 750 MPa, greater than or equal to about 1000 MPa, or even greater than or equal to about 1250 MPa. In embodiments, the aliphatic polyketone may have a tensile modulus less than or equal to about 2000 MPa, less than or equal to about 1750 MPa, or even less than or equal to about 1500 MPa. In embodiments, the aliphatic polyketone may have a tensile modulus from about 750 MPa to about 2000 MPa, from about 750 MPa to about 1750 MPa, from about 750 MPa to about 1500 MPa, from about 1000 MPa to about 2000 MPa, from about 1000 MPa to about 1750 MPa, from about 1000 MPa to about 1500 MPa, from about 1250 MPa to about 2000 MPa, from about 1250 MPa to about 1750 MPa, or even from about 1250 MPa to about 1500 MPa, or any and all subranges formed from these endpoints.

In embodiments, the aliphatic polyketone may have a specific gravity greater than or equal to about 1.1 or even greater than or equal to about 1.2. In embodiments, the aliphatic polyketone may have a specific gravity less than or equal to about 1.4 or even less than or equal to about 1.3. In embodiments, the aliphatic polyketone may have a specific gravity from about 1.1 to about 1.4, from about 1.1 to about 1.3, from about 1.2 to about 1.4, or even from about 1.2 to about 1.3, or any and all subranges formed from any of these endpoints.

The dynamically vulcanized composition may include at least 5 wt % aliphatic polyketone to ensure improved heat resistance and processability. Accordingly, in embodiments, the dynamically vulcanized composition may comprise, based on a total weight of the dynamically vulcanized composition, about 5 wt % to about 70 wt % of an aliphatic polyketone. In embodiments, the amount of the aliphatic polyketone in the dynamically vulcanized composition may be, based on a total weight of the dynamically vulcanized composition, greater than or equal to about 5 wt %, greater than or equal to about 10 wt %, greater than or equal to about 20 wt %, greater than or equal to about 30 wt %, greater than or equal to about 40 wt %, or even greater than or equal to 50 wt %. In embodiments, the amount of the aliphatic polyketone in the dynamically vulcanized composition may be, based on a total weight of the dynamically vulcanized composition, less than or equal to about 70 wt %, less than or equal to about 67 wt %, less than or equal to about 65 wt %, less than or equal to about 63 wt %, or even less than or equal to about 60 wt %. In embodiments, the amount of the aliphatic polyketone in the dynamically vulcanized composition may be, based on a total weight of the dynamically vulcanized composition, from about 5 wt % to about 70 wt %, from about 5 wt % to about 67 wt %, from about 5 wt % to about 65 wt %, from about 5 wt % to about 63 wt %, from about 5 wt % to about 60 wt %, from about 10 wt % to about 70 wt %, from about 10 wt % to about 67 wt %, from about 10 wt % to about 65 wt %, from about 10 wt % to about 63 wt %, from about 10 wt % to about 60 wt %, from about 20 wt % to about 70 wt %, from about 20 wt % to about 67 wt %, from about 20 wt % to about 65 wt %, from about 20 wt % to about 63 wt %, from about 20 wt % to about 60 wt %, from about 30 wt % to about 70 wt %, from about 30 wt % to about 67 wt %, from about 30 wt % to about 65 wt %, from about 30 wt % to about 63 wt %, from about 30 wt % to about 60 wt %, from about 40 wt % to about 70 wt %, from about 40 wt % to about 67 wt %, from about 40 wt % to about 65 wt %, from about 40 wt % to about 63 wt %, from about 40 wt % to about 60 wt %, from about 50 wt % to about 70 wt %, from about 50 wt % to about 67 wt %, from about 50 wt % to about 65 wt %, from about 50 wt % to about 63 wt %, or even from about 50 wt % to about 60 wt %, or any and all subranges formed from any of these endpoints.

Suitable commercial embodiments of the aliphatic polyketone are available from Hyosung Corporation, such as grade M630S.

### Functionalized Rubber

The dynamically vulcanized composition described herein comprises a functionalized rubber. In embodiments, the functionalized rubber includes a polymer chain with functional groups located along the polymer chain. The polymer chain of the functionalized rubber may be linear or include one or more branches. A reactive group of the functionalized rubber may react with the low-odor crosslinking compound and crosslink, thereby ensuring improved heat resistance and flexibility.

In embodiments, the functionalized rubber may have a glass transition temperature less than or equal to 23° C.

In embodiments, the functionalized rubber may be selected from the group consisting of a functionalized acrylic rubber, methacrylate rubber, acrylic acid rubber, methacrylic acid rubber, acrylonitrile-styrene-acrylate, ethylene propylene diene rubber, ethylene acrylic acid rubber, butadiene rubber, isoprene rubber, styrene-butadiene rubber, styrene-ethylene-butadiene rubber, a functionalized nitrile rubber, or any combination thereof. In embodiments, the functionalized rubber may be hydrogenated.

In embodiments, the functionalized rubber may include a pendant functional group selected from the group consisting of epoxides, sulfur-containing groups, carboxyls, amides, maleic anhydride, maleic acid, alkenes, and alkynes.

The dynamically vulcanized composition may include at least about 30 wt % of a functionalized rubber to ensure improved flexibility. The amount of functionalized rubber may be limited (e.g., less than or equal to about 95 wt %) to maintain processability of the dynamically vulcanized composition. Accordingly, in embodiments, the dynamically vulcanized composition may comprise, based on a total weight of the dynamically vulcanized composition about 30 wt % to about 95 wt % of a functionalized rubber. In embodiments, the amount of the functionalized rubber in the dynamically vulcanized composition may be, based on a total weight of the dynamically vulcanized composition, greater than or equal to about 30 wt %, greater than or equal to about 33 wt %, greater than or equal to about 35 wt %, greater than or equal to about 37 wt %, or even greater than or equal to about 40 wt %. In embodiments, the amount of the functionalized rubber in the dynamically vulcanized composition may be, based on a total weight of the dynamically vulcanized composition, less than or equal to about 95 wt %, less than or equal to about 90 wt %, less than or equal to about 80 wt %, less than or equal to about 70 wt %, less than or equal to about 60 wt %, or even less than or equal to about 50 wt %. In embodiments, the amount of the functionalized rubber in the dynamically vulcanized composition may be, based on a total weight of the dynamically vulcanized composition, from about 30 wt % to about 95 wt %, from about 30 wt % to about 90 wt %, from about 30 wt % to about 80 wt %, from about 30 wt % to about 70 wt %, from about 30 wt % to about 60 wt %, from about 30 wt % to about 50 wt %, from about 33 wt % to about 95 wt %, from about 33 wt % to about 90 wt %, from about 33 wt % to about 80 wt %, from about 33 wt % to about 70 wt %, from about 33 wt % to about 60 wt %, from about 33 wt % to about 50 wt %, from about 35 wt % to about 95 wt %, from about 35 wt % to about 90 wt %, from about 35 wt % to about 80 wt %, from about 35 wt % to about 70 wt %, from about 35 wt % to about 60 wt %, from about 35 wt % to about 50 wt %, from about 37 wt % to about 95 wt %, from about 37 wt % to about 90 wt %, from about 37 wt % to about 80 wt %, from about 37 wt % to about 70 wt %, from about 37 wt % to about 60 wt %, from about 37 wt % to about 50 wt %, from about 40 wt % to about 95 wt %, from about 40 wt % to about 90 wt %, from about 40 wt % to about 80 wt %, from about 40 wt % to about 70 wt %, from about 40 wt % to about 60 wt %, or even from about 40 wt % to about 50 wt %, or any and all subranges formed from any of these endpoints.

Suitable commercial embodiments of the functionalized rubber are available under the HYTEMP brand from Zeon Corporation, such as functionalized polyacrylate grade AR212HR.

### Low-Odor Crosslinking Compound

The dynamically vulcanized composition described herein comprises a low-odor crosslinking compound. The low-odor crosslinking compound is capable of reacting with the ketone groups of the aliphatic polyketone and the functional groups of the functionalized rubber. Accordingly, the low-odor crosslinking compound may form crosslinks between aliphatic polyketones, between functionalized rubbers, and between a functional rubber and an aliphatic polyketone. As described herein, the low-odor crosslinking compound improves the miscibility between the aliphatic polyketone and the functionalized rubber, thereby improving the heat resistance and flexibility of the resulting dynamically vulcanized composition.

Because the dynamically vulcanized compositions described herein result from relatively quick crosslinking (e.g., within an extruder), a low-odor crosslinking compound having a relatively high average molecular weight (e.g., greater than or equal to about 200 g/mol) may be used. A compound having a relatively high average molecular weight may be relatively less volatile at the processing temperatures. In embodiments, the low-odor crosslinking compound may have an average molecular weight greater than or equal to about 200 g/mol, greater than or equal to about 250 g/mol, greater than or equal to about 300 g/mol, greater than or equal to about 350 g/mol, or even greater than or equal to about 400 g/mol. In embodiments, the low-odor crosslinking compound may have an average molecular weight less than or equal to about 1200 g/mol, greater than or equal to about 1100 g/mol, greater than or equal to about 1000 g/mol, greater than or equal to about 900 g/mol, or even greater than or equal to about 800 g/mol. In embodiments, the low-odor crosslinking compound may have an average molecular weight of about 200 g/mol to about 1200 g/mol, of about 250 g/mol to about 1100 g/mol, of about 300 g/mol to about 1000 g/mol, of about 350 g/mol to about 900 g/mol, of about 400 g/mol to about 800 g/mol, or any and all subranges formed from any of these endpoints.

In embodiments, the low-odor crosslinking compound may selected from the group consisting of diamines, triamines, multifunctional amines, diols, triols, multifunctional alcohols, dithiols, thiols, carboxylic acids, zwitterions salts, alkenes, and conjugated dienes.

In embodiments, the low-odor crosslinking compound may be a di-functional crosslinking compound. For example, in embodiments, the low-odor crosslinking compound may be defined by formula (I):

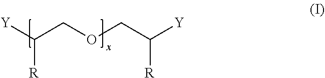

wherein each R may be individually selected from a hydrogen atom or a methyl group, x may be from 4 to 120, and each Y may be individually a functional group selected from the group consisting of amines, alcohols, thiols, carboxylic acids, alkenes, and conjugated dienes. For example, in embodiments, the low-odor crosslinking compound may be defined by formula (II):

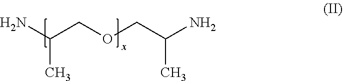

wherein x may be from 4 to 120.

In embodiments in which the low-odor crosslinking compound is defined by formula (I) or formula (II), x may be from 4 to 120, from 4 to 100, from 4 to 80, from 4 to 60, from 4 to 40, from 4 to 20, from 4 to 10, from 5 to 120, from 5 to 100, from 5 to 80, from 5 to 60, from 5 to 40, from 5 to 20, from 5 to 10, from 6 to 120, from 6 to 100, from 6 to 80, from 6 to 60, from 6 to 40, from 6 to 20, or even from 6 to 10, or any and all subranges formed from any of these endpoints.

In embodiments, the low-odor crosslinking compound may be a multi-functional crosslinking compound that includes three or more functional groups. For example, in embodiments, the low-odor crosslinking compound may be defined by formula (III):

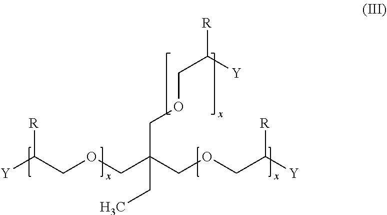

wherein each R may be individually selected from a hydrogen atom or a methyl group, each x may be from 1 to 40, and the total sum of the x units may be from 3 to 120, and each Y may be individually a functional group selected from the group consisting of amines, alcohols, thiols, carboxylic acids, alkenes and conjugated dienes. For example, in embodiments, the low-odor crosslinking compound may be defined by formula (IV):

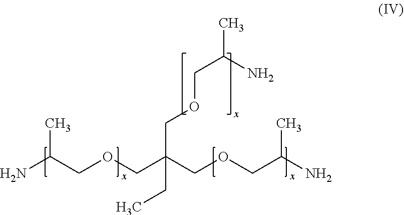

wherein each x may be from 1 to 40, and the total sum of the x units may be from 3 to 120.

In embodiments in which the low-odor crosslinking compound is defined by formula (III) or formula (IV), each x may be from 1 to 40, from 1 to 30, from 1 to 20, from 1 to 10, from 2 to 40, from 2 to 30, from 2 to 20, from 2 to 10, from 4 to 40, from 4 to 30, from 4 to 20, from 4 to 10, from 6 to 40, from 6 to 30, from 6 to 20, or even from 6 to 10, or any and all subranges formed from any of these endpoints. In embodiments in which the low-odor crosslinking compound is defined by formula (III) or formula (IV), the total sum of the x units may be from 3 to 120, from 3 to 90, from 3 to 60, from 3 to 30, from 6 to 120, from 6 to 90, from 6 to 60, from 6 to 30, from 12 to 120, from 12 to 90, from 12 to 60, from 12 to 30, from 18 to 120, from 18 to 90, from 18 to 60, or even from 18 to 30, or any and all subranges formed from any of these endpoints.

In other embodiments in which the low-odor crosslinking compound may be a multi-functional crosslinking compound that includes three or more functional groups, the low-odor crosslinking compound may be defined by formula (V):

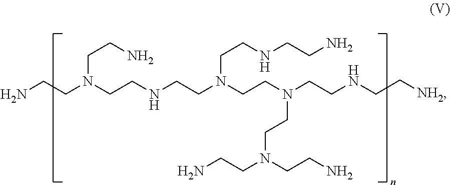

wherein n may be from 1 to 50. In embodiments in which the low-odor crosslinking compound is defined by formula (V), n may be from 1 to 50, from 1 to 40, from 1 to 30, from 1 to 20, from 1 to 10, from 1 to 5, or even from 1 to 3.

The dynamically vulcanized composition may include at least 0.1 wt % of a low-odor crosslinking compound to ensure miscibility between the aliphatic polyketone and the functionalized rubber. The amount of low-odor crosslinking compound may be limited (e.g., less than or equal to about 5 wt %) to ensure that properties of the dynamically vulcanized composition are due to the occurrence of crosslinking of the aliphatic polyketone and/or the functionalized rubber, not because of a relatively large amount of low-odor crosslinking compound. Accordingly, in embodiments, the dynamically vulcanized composition may comprise, based on a total weight of the dynamically vulcanized composition, about 0.1 wt % to about 5 wt % of a low-odor crosslinking compound. In embodiments, the amount of the low-odor crosslinking compound in the dynamically vulcanized composition may be, based on a total weight of the dynamically vulcanized composition, greater than or equal to about 0.1 wt %, greater than or equal to about 0.25 wt %, or even greater than or equal to about 0.5 wt %. In embodiments, the amount of the low-odor crosslinking compound in the dynamically vulcanized composition may be, based on a total weight of the dynamically vulcanized composition, less than or equal to about 5 wt %, less than or equal to about 4 wt %, less than or equal to about 3 wt %, less than or equal to about 2 wt %, or even less than or equal to about 1 wt %. In embodiments, the amount of the low-odor crosslinking compound in the dynamically vulcanized composition may be, based on a total weight of the dynamically vulcanized composition, from about 0.1 wt % to about 5 wt %, from about 0.1 wt % to about 4 wt %, from about 0.1 wt % to about 3 wt %, from about 0.1 wt % to about 2 wt %, from about 0.1 wt % to about 1 wt %, from about 0.25 wt % to about 5 wt %, from about 0.25 wt % to about 4 wt %, from about 0.25 wt % to about 3 wt %, from about 0.25 wt % to about 2 wt %, from about 0.25 wt % to about 1 wt %, from about 0.5 wt % to about 5 wt %, from about 0.5 wt % to about 4 wt %, from about 0.5 wt % to about 3 wt %, from about 0.5 wt % to about 2 wt %, or even from about 0.5 wt % to about 1 wt %, or any and all subranges formed from any of these endpoints.

In embodiments, one low-odor crosslinking compound may be employed to produce a dynamically vulcanized composition. In other embodiments, two or more low-odor crosslinking compound may be employed. For example, two or more low-odor crosslinking compounds selected from formula I, II, III, IV, and V may be employed.

Suitable commercial embodiments of the low-odor crosslinking compound are available under the JEFFAMINE brand from Huntsman, such as polyetheramine grade T-403 or polyetheramine grade D-400.

### Dynamically Vulcanized Composition

As described herein, the inclusion of a low-odor crosslinking compound to crosslink the aliphatic polyketone and the functionalized rubber reduces the compression set, Shore A hardness, and tensile modulus. In particular, the low-odor crosslinking compound improves the miscibility between the aliphatic polyketone and the functionalized rubber.

In embodiments, the aliphatic polyketone may form a matrix and the functionalized rubber may form particles that are dispersed in the aliphatic polyketone matrix. In such embodiments, the functionalized rubber may have a particle size distribution D50, as measured by atomic force microscopy, less than or equal to about 15 microns, less than or equal to about 12 microns, less than or equal to about 10 microns, less than or equal to about 8 microns, less than or equal to about 5 microns, less than or equal to about 3 microns, or even less than or equal to about 1 microns. In embodiments, the functionalized rubber may form a matrix and the aliphatic polyketone may form particles that may be dispersed in the rubber matrix. In such embodiments, the aliphatic polyketone may have a particle size distribution D50, as measured by atomic force microscopy, less than or equal to about 15 microns, less than or equal to about 12 microns, less than or equal to about 10 microns, less than or equal to about 8 microns, less than or equal to about 5 microns, less than or equal to about 3 microns, or even less than or equal to about 1 microns. In embodiments, the functionalized rubber and the aliphatic polyketone may form a co-continuous phase. In embodiments, the dynamically vulcanized composition may include multiple regions within the composition, In embodiments, the dynamically vulcanized composition may include at least two regions selected from the group of functionalized rubber particles dispersed in an aliphatic polyketone matrix, aliphatic polyketone particles dispersed in an functionalized rubber matrix, and a co-continuous phase of the functionalized rubber and the aliphatic polyketone.

In embodiment, the low-odor crosslinking compound may form crosslinks within the dynamically vulcanized composition between the aliphatic polyketone, between the functionalized rubber, and between the aliphatic polyketone and the functionalized rubber.

In embodiments, the dynamically vulcanized composition may comprise a reduced compression set, which is indicative of improved heat resistance. In embodiments, the dynamically vulcanized composition may comprise a compression set (22 h, 150° C.) less than or equal to about 95%, less than or equal to about 93%, less than or equal to about 91%, or even less than or equal to about 89%.

In embodiment, the dynamically vulcanized composition may comprise a reduced Shore A hardness and tensile modulus, which are indicative of improved flexibility. In embodiments, the dynamically vulcanized composition may comprise a Shore A hardness less than or equal to about 85, less than or equal to about 80, less than or equal to about 75, less than or equal to about 70, less than or equal to about 65, or even less than or equal to about 55. In embodiments, the dynamically vulcanized composition may comprise a tensile modulus less than or equal to about 250 MPa, less than or equal to about 100 MPa, less than or equal to about 50 MPa, less than or equal to about 25 MPa, or even less than or equal to about 10 MPa.

As exemplified in the Examples section below, the dynamically vulcanized compositions described herein comprising the reaction product of an aliphatic polyketone, a functionalized rubber, and a low-odor crosslinking compound having improved heat resistance (i.e., reduced compression set) and improved flexibility (i.e., reduced Shore A hardness and tensile modulus).

### Additives

In embodiments, the dynamically vulcanized composition may further comprise an additive. In embodiments, the additive may comprise antioxidants, stabilizers, adhesion promoters; biocides; anti-fogging agents; anti-static agents; blowing and foaming agents; bonding agents and bonding polymers; dispersants; flame retardants and smoke suppressants; mineral fillers; initiators; lubricants; micas; pigments, colorants, and dyes; processing aids; release agents; silanes, titanates, and zirconates; slip and anti-blocking agents; stearates; ultraviolet light absorbers; viscosity regulators; waxes; nanoparticles; or combinations thereof. Suitable nanoparticles include, but are not limited to, nanoclay and graphene. In embodiments, nanoclay may have an aspect ratio range in the range of about 200:1 to about 1000:1. In embodiments, graphene may have an aspect ratio range in the range of about 1000:1 to about 2000:1.

### Processing

In embodiments, the dynamically vulcanized composition described herein may be made with a batch process or continuous process.

In embodiments, the components of the dynamically vulcanized composition, including the aliphatic polyketone, the functionalized rubber, and the low-odor crosslinking compound, may be added to an extruder (27 MM Leistritz Twin Extruder (L/D 60)) and blended. In embodiments, the blending (e.g., in the barrel of the extruder) may be carried out at a temperature in the range of 150° C. to 270° C.

Blending (also known as compounding) devices are well known to those skilled in the art and generally include means of feeding, especially at least one hopper for pulverulent materials and/or at least one injection pump for liquid materials; high-shear blending means, for example a co-rotating or counter-rotating twin-screw extruder, usually comprising a feed screw placed in a heated barrel (or tube); an output head, which gives the extrudate its shape; and means for cooling the extrudate, either by air cooling or by circulation of water. The extrudate is generally in the form of rods continuously exiting the device and able to be cut or formed into granules. However, other forms may be obtained by fitting a die of desired shape on the output die.

### EXAMPLES

Table 1 below shows sources of ingredients used to form Comparative Examples C1 to C4 and Examples E1 and E2.

TABLE 1

| Ingredients | Brand | Source |
|---|---|---|
| aliphatic polyketone | M630S | Hyosung Corporation |
| polyamide resin | PRIME PLT | Grupa Azoty |
| (Nylon 6 (PA6)) | | |
| functionalized rubber | HYTEMP AR212HR | Zeon Corporation |
| (functionalized | | |
| polyacrylate) | | |
| low-odor crosslinking | JEFFAMINE D-400 | Huntsman |
| compound | | |
| (polyetheramine) | | |
| antioxidant | IRGANOX 1098 | BASF |
| calcium phosphate | EPSOLUTE C13-09 | Budenheim |
| talc-dusting agent | MISTRON VAPOR R | Imerys |

Table 2 below show the formulations (in wt %) used to form and the certain properties of Comparative Examples C1 to C4 and Examples E1 and E2.

TABLE 2

| | C1 | C2 | C3 | C4 | E1 | E2 |
|---|---|---|---|---|---|---|
| M630S | 53.87 | 61.75 | 0 | 0 | 53.50 | 60.70 |
| PRIME PLT | 0 | 0 | 53.87 | 53.50 | 0 | 0 |
| HYTEMP AR212HR | 44.07 | 36.41 | 44.07 | 43.77 | 43.77 | 36.70 |
| JEFFAMINE D-400 | 0 | 0 | 0 | 0.68 | 0.68 | 0.75 |
| IRGANOX 1098 | 0.24 | 0.25 | 0.24 | 0.24 | 0.24 | 0.25 |
| EPSOLUTE C13-09 | 0.50 | 0.50 | 0.50 | 0.50 | 0.50 | 0.50 |
| MISTRON VAPOR R | 1.32 | 1.09 | 1.32 | 1.31 | 1.31 | 1.10 |
| TOTAL | 100.00 | 100.00 | 100.00 | 100.00 | 100.00 | 100.00 |
| Hardness (Shore A) | 90.4 | 93.1 | 93.9 | 93.8 | 61.8 | 54.5 |
| Tensile modulus (MPa) | 445.92 | 469.51 | 693.14 | 780.36 | 13.18 | 4.20 |
| Compression set | 96.82 | 96.93 | 106.84 | 108.46 | 88.76 | 93.39 |
| (22 h, 150° C., %) | | | | | | |

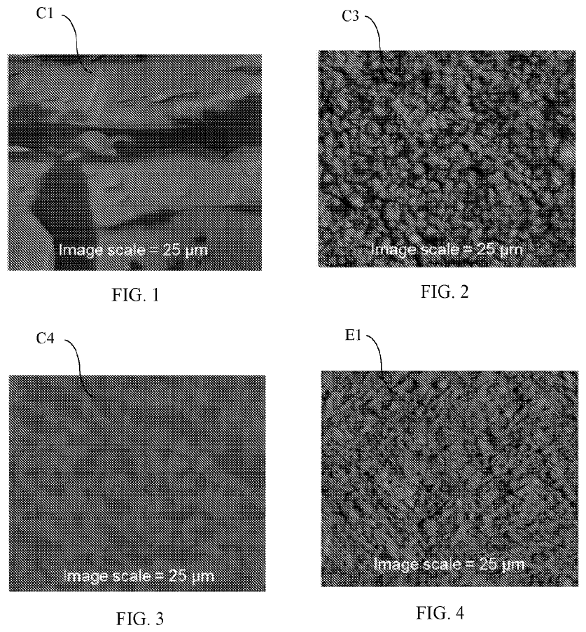

Referring now to FIGS. 1-4, Comparative Examples C1, C3, and C4 and Example E1 were subjected to atomic force microscopy using a Bruker Multimode. Example E1, a dynamically vulcanized composition including an aliphatic polyketone (M630S), a functionalized rubber (HYTEMP AR212HR), and a low-odor crosslinking compound (JEFFAMINE D-400), included well dispersed aliphatic polyketone and functionalized phases. In contrast, Comparative Example C1, a composition lacking a low-odor crosslinking compound, included large aliphatic polyketone and functionalized rubber phases. Example E1 also included smaller, more well dispersed rubber domains as compared to Comparative Example C4, a composition including a polyamide resin (PRIME PLT), functionalized rubber, and a low-odor crosslinking compound. As indicated by FIGS. 1-4, a low-odor crosslinking compound improves the miscibility of aliphatic polyketone with functionalized rubber, whereas the low-odor crosslinking compound increases rubber domain size via crosslinking the functionalized rubber in the polyamide resin continuous phase.

Referring back to Table 2, Examples E1 and E2, dynamically vulcanized compositions including an aliphatic polyketone (M630S), a functionalized rubber (HYTEMP AR212HR), and a low-odor crosslinking compound (JEFFAMINE D-400) had a reduced compression set, hardness, and tensile modulus as compared to Comparative Examples C1 and C2 (i.e., compositions including aliphatic polyketone and functionalized rubber and lacking a low-odor crosslinking compound), Comparative Example C3 (i.e., a composition including a polyamide resin (PRIME PLT) and functionalized rubber and lacking a low-odor crosslinking compound), and Comparative Example C4 (i.e., a composition including a polyamide resin, functionalized rubber, and a low-odor crosslinking compound. As indicated by Comparative Examples C1 to C4 and Examples E1 and E2, using a low-odor crosslinking compound improves miscibility between the aliphatic polyketone and functionalized rubber, resulting in a heat resistant and flexible dynamically vulcanized composition.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A dynamically vulcanized composition comprising the reaction product of, based on a total weight of the dynamically vulcanized composition:
about 5 wt % to about 70 wt % of an aliphatic polyketone;
about 30 wt % to about 95 wt % of a functionalized rubber; and
about 0.1 wt % to about 5 wt % of a low-odor crosslinking compound.

2. The dynamically vulcanized composition of claim 1, wherein the functionalized rubber has a glass transition temperature less than or equal to 23° C.

3. The dynamically vulcanized composition of claim 1, wherein the functionalized rubber is selected from the group consisting of a functionalized acrylic rubber, methacrylate rubber, acrylic acid rubber, methacrylic acid rubber, acrylonitrile-styrene-acrylate, ethylene propylene diene rubber, ethylene acrylic acid rubber, butadiene rubber, isoprene rubber, styrene-butadiene rubber, styrene-ethylene-butadiene rubber, a functionalized nitrile rubber, or any combination thereof.

4. The dynamically vulcanized composition of claim 1, wherein the functionalized rubber is hydrogenated.

5. The dynamically vulcanized composition of claim 1, wherein the functionalized rubber includes a pendant functional group selected from the group consisting of epoxides, sulfur-containing groups, carboxyls, amides, maleic anhydride, maleic acid, alkenes, and alkynes.

6. The dynamically vulcanized composition of claim 1, wherein the aliphatic polyketone has a melt flow rate greater than or equal to about 3 g/10 min, measured in accordance to ASTM D1238 at 240° C. and a weight of 2.16 kg.

7. The dynamically vulcanized composition of claim 1, wherein the aliphatic polyketone has a melt flow rate less than or equal to about 200 g/10 min, measured in accordance to ASTM D1238 at 240° C. and a weight of 2.16 kg.

8. The dynamically vulcanized composition of claim 1, wherein the low-odor crosslinking compound has an average molecular weight greater than or equal to about 200 g/mol.

9. The dynamically vulcanized composition of claim 1, wherein the low-odor crosslinking compound is selected from the group consisting of diamines, triamines, multifunctional amines, diols, triols, multifunctional alcohols, dithiols, thiols, carboxylic acids, zwitterions salts, alkenes, and conjugated dienes.

10. The dynamically vulcanized composition of claim 1, wherein the low-odor crosslinking compound is a di-functional crosslinking compound.

11. The dynamically vulcanized composition of claim 10, wherein the low-odor crosslinking compound is defined by one or more of formula (I): 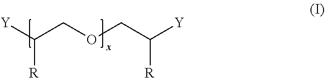
wherein each R is individually selected from a hydrogen atom or a methyl group, x is from 4 to 120, and each Y is individually a functional group selected from the group consisting of amines, alcohols, thiols, carboxylic acids, alkenes, and conjugated dienes; 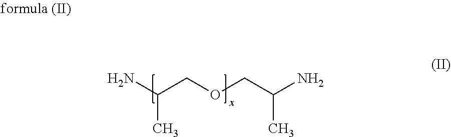
wherein x is from 4 to 120; 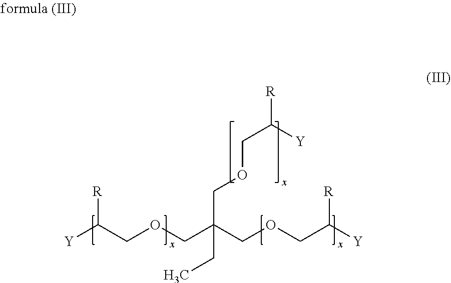
wherein each R is individually selected from a hydrogen atom or a methyl group, each x is from 1 to 40, and the total sum of the x units is from 3 to 120, and each Y is individually a functional group selected from the group consisting of amines, alcohols, thiols, carboxylic acids, alkenes, and conjugated dienes; 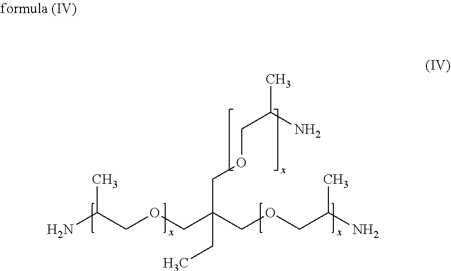
wherein each x is from 1 to 40, and the total sum of the x units is from 3 to 120; or formula (V): 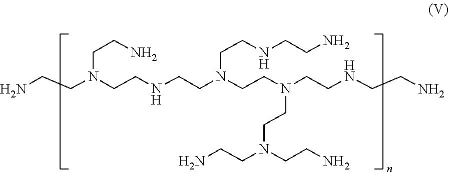
wherein n is from 1 to 50.

12-16. (canceled)

17. The dynamically vulcanized composition of claim 1, wherein the aliphatic polyketone forms a matrix and the functionalized rubber forms particles that are dispersed in the aliphatic polyketone matrix.

18. The dynamically vulcanized composition of claim 17, wherein the particles of the functionalized rubber have a particle size distribution less than or equal to about 15 microns.

19. The dynamically vulcanized composition of claim 1, wherein the functionalized rubber forms a matrix and the aliphatic polyketone forms particles that are dispersed in the rubber matrix.

20. The dynamically vulcanized composition of claim 1, wherein the functionalized rubber and the aliphatic polyketone form a co-continuous phase.

21. The dynamically vulcanized composition of claim 1, wherein the low-odor crosslinking compound forms crosslinks within the dynamically vulcanized composition between the aliphatic polyketone, between the functionalized rubber, and between the aliphatic polyketone and the functionalized rubber.

22. The dynamically vulcanized composition of claim 1, wherein dynamically vulcanized composition is free of a polyamide polymer.
